(19) United States
(12) Patent Application Publication
(10) Pub. No.: US 2014/0235295 A1
(43) Pub. Date: Aug. 21, 2014

(54) INCOMING CALL PROCESSING METHOD OF MOBILE TERMINAL, MOBILE TERMINAL AND STORAGE MEDIUM

(71) Applicant: Tencent Technology (Shenzhen) Company Limited, Guangdong (CN)

(72) Inventors: Liwei YE, Guangdong (CN); Wei YI, Guangdong (CN); Zengxiang LV, Guangdong (CN); Bin LI, Guangdong (CN)

(73) Assignee: Tencent Technology (Shenzhen) Company Limited, Guangdong (CN)

(21) Appl. No.: 14/227,409

(22) Filed: Mar. 27, 2014

Related U.S. Application Data
(63) Continuation of application No. PCT/CN2013/087212, filed on Nov. 15, 2013.

(30) Foreign Application Priority Data
Feb. 21, 2013 (CN) 201310055730.7

(51) Int. Cl. H04M 1/725

(52) U.S. Cl. CPC H04M 1/72597
USPC 455/566

(57) ABSTRACT

An incoming call processing method of a mobile terminal and a mobile terminal, and the method includes: displaying, by a mobile terminal, a customized slidable incoming call interface when an incoming call is received; receiving an answering or rejecting slide operation instruction triggered by a user on the customized slidable incoming call interface; and invoking a corresponding system interface to answer or reject the call according to the received slide operation instruction. In the method, by performing an incoming call answering or rejecting operation on a customized incoming call interface of a mobile terminal in a uniform slide mode, the efficiency and accuracy of the call answering or rejecting operation of a user may be improved; additionally, the pattern of an incoming call interface, etc., may also be customized according to user requirement.

### CROSS-REFERENCE TO RELATED APPLICATION

This application claims priority to and is a continuation application of PCT/CN2013/087212, filed on Nov. 15, 2013 and entitled “INCOMING CALL PROCESSING METHOD OF MOBILE TERMINAL, MOBILE TERMINAL AND STORAGE MEDIUM”, which claims the benefit of Chinese Application No. 201310055730.7, filed on Feb. 21, 2013 by Tencent Technology (Shenzhen) Co., Ltd., titled “INCOMING CALL PROCESSING METHOD OF MOBILE TERMINAL, AND MOBILE TERMINAL”, which are incorporated herein by reference in their entirety.

### FIELD OF THE INVENTION

The present disclosure relates to the field of mobile communication and Internet technologies, and in particular to an incoming call processing method of a mobile terminal, a mobile terminal and a storage medium.

### BACKGROUND OF THE INVENTION

Due to the features of brief design and handy operation, an IOS platform is accepted by more and more users, and its market share increases continuously. However, because the design of the IOS platform mainly emphasizes on entertainment and leisure, routine operations such as call dialing are not perfectly supported in the IOS platform.

So far, the IOS system provides different answering and rejecting modes for an incoming call in a screen lock state and a screen unlock state.

When an incoming call is received in the screen lock state, the user may choose to answer the call by sliding a scroll bar to the right on the call interface, or to reject the call only by pressing a power button twice. However, when an incoming call is received in the screen unlock state, a rejecting button is arranged on the left and an answering button is arranged on the right on the call interface, and the user answers the call by clicking the answering button or rejects the call by clicking the rejecting button.

The existing solution in which different answering and rejecting modes are provided for an incoming call has the following defects:

1) The answering and rejecting modes are not uniform, particularly, the IOS system provides different answering and rejecting solutions for the screen lock state and the screen unlock state, respectively, which causes a high learning cost for a user. Especially, to reject the incoming call in the screen lock state, the power key has to be pressed twice, which is unknown to most users who just start to use the IOS system.

2) A maloperation occurs with a certain probability. For the screen unlock state, when an incoming call is received, the user performs an answering or rejecting operation with a button provided by the system; in such a case, a maloperation occurs with a certain probability. For example, when taking out the mobile phone from a pocket, the user may unconsciously press the undesired answering or rejecting button.

Therefore, the existing modes of answering and rejecting an incoming call are inconvenient for the user, and the user requires a uniform, handy and accurate operation mode.

### SUMMARY OF THE INVENTION

Therefore, an incoming call processing method of a mobile terminal, and a mobile terminal is provided, thereby improving the efficiency and accuracy of operations on the incoming call.

The incoming call processing method of a mobile terminal, comprises:

displaying, by a mobile terminal, a customized slidable incoming call interface when an incoming call is received;

receiving an answering slide operation instruction or a rejecting slide operation instruction triggered by a user on the customized slidable incoming call interface; and

invoking a corresponding system interface to answer or reject the incoming call according to the received slide operation instruction.

The disclosure further puts forward a mobile terminal for processing an incoming call, which comprises:

a displaying module, configured to display a customized slidable incoming call interface when an incoming call is received;

a receiving module, configured to receive an answering slide operation instruction or a rejecting slide operation instruction triggered by a user on the customized slidable incoming call interface; and

an operating module, configured to invoke a corresponding system interface to answer or reject the call according to the received slide operation instruction.

The disclosure further puts forward a storage medium containing computer-executable instructions, wherein the computer-executable instructions are configured to perform an incoming call processing method of a mobile terminal, and the method comprises steps of:

displaying, by a mobile terminal, a customized slidable incoming call interface when an incoming call is received;

receiving an answering slide operation instruction or a rejecting slide operation instruction triggered by a user on the customized slidable incoming call interface; and

invoking a corresponding system interface to answer or reject the call according to the received slide operation instruction.

In the incoming call processing method of a mobile terminal, the mobile terminal and the storage medium according to the disclosure, an incoming call answering or rejecting operation is performed on a customized incoming call interface of a mobile terminal in a uniform slide mode, as a result, the efficiency and accuracy of the call answering or rejecting operation of a user may be improved; additionally, the pattern of an incoming call interface, etc., may also be customized according to user requirement, so that the operation of a user on an incoming call may be facilitated, and the shortage of the prior art, especially of the call answering in an IOS system, may be covered.

### BRIEF DESCRIPTION OF THE DRAWINGS

FIG. 1 is a schematic flow chart of one embodiment of the incoming call processing method of a mobile terminal according to the disclosure;

FIG. 2 is a schematic flow chart of another embodiment of the incoming call processing method of a mobile terminal according to the disclosure;

FIG. 3 is a schematic flow chart of yet another embodiment of the incoming call processing method of a mobile terminal according to the disclosure;

FIG. 4 is a structural representation of one embodiment of the mobile terminal for processing an incoming call according to the disclosure;

FIG. 5 is a structural representation of another embodiment of the mobile terminal for processing an incoming call according to the disclosure; and

FIG. 6 is a structural representation of yet another embodiment of the mobile terminal for processing an incoming call according to the disclosure.

In order to make the technical solutions of the disclosure clear and apparent, further detailed description will be given below in conjunction with the drawings.

### DETAILED DESCRIPTION OF THE EMBODIMENTS

The solution according to the embodiments of the disclosure is mainly as follows: a mobile terminal displays a customized incoming call interface with slide operations when an incoming call is received, receives an answering slide operation instruction or a rejecting slide operation instruction triggered by a user on the customized slidable incoming call interface, and invokes a corresponding system interface to answer or reject the call according to the received slide operation instruction. As a result, the call is answered or rejected by the uniform manner of sliding on the customized incoming call interface of the mobile terminal, so that the efficiency and accuracy of answering or rejecting the call by the user may be improved.

As shown in FIG. 1, one embodiment of the disclosure puts forward an incoming call processing method of a mobile terminal, which includes Steps S101-S103 below.

At Step S101, a mobile terminal displays a customized slidable incoming call interface when an incoming call is received.

The solution according to this embodiment may be applied to the IOS system platform or other system platforms, and herein the description is given by taking the IOS system platform as an example. The mobile terminal in this embodiment may be a mobile phone, an iPAD, etc.

In this embodiment, the two different answering solutions provided by the existing IOS system platform may be integrated, and the mode of answering or rejecting an incoming call by sliding on the incoming call interface may be provided to a user in both the screen lock state and the screen unlock state, for example, the incoming call is rejected by sliding “to the left” and answered by sliding “to the right”. In such a mode, the learning cost of a user is reduced, and the maloperation which may occur in the case of pressing a button may be avoided.

Specifically, in this embodiment, when an incoming call is received by a mobile terminal, an incoming call interface on which the user may perform a slide operation appears on the screen of the mobile terminal. This incoming call interface is a customized slidable incoming call interface provided to the user, which may be various slide operation interfaces customized by the user in advance according to individual preference, for example, the user may defines to reject a call by sliding to the left on the interface and to answer a call by sliding to the right on the interface, or defines to reject a call by sliding up and to answer a call by sliding down on the interface, or in other slide modes.

Further, the user may also define the slidable incoming call interface as a static or dynamic interface as required, for example, a dynamic background picture is set for the incoming call interface; or, the incoming call interface is set as a ringing interface carrying the corresponding incoming call number, etc.

At Step S102, an answering slide operation instruction or a rejecting slide operation instruction triggered by a user on the customized slidable incoming call interface is received.

After the mobile terminal receives an incoming call, the user performs a corresponding slide operation as required on the incoming call interface of the mobile terminal according to the slide mode displayed on the incoming call interface, so as to trigger the mobile terminal to answer or reject the incoming call.

At Step S103, a corresponding system interface is invoked to answer or reject the call according to the slide operation instruction.

The mobile terminal performs the corresponding operation after receiving the slide operation instruction inputted by the user, for example, when the user slides to the left on the customized incoming call interface as displayed, a call rejecting interface is invoked in the system; when the user slides to the right, a call answering interface is invoked in the system. Therefore, the corresponding call operation is implemented.

Here, when the user rejects the incoming call, the system may further conduct a shortcut reply, for example, by sending a prompt short message such as “in conference”, “in class” and so on to the caller.

For example, for the existing IOS system platform, when a call is received, a system call program is invoked to initialize and generate an incoming call interface, and the system call program returns different answering and rejecting interfaces according to the current state of the IOS system (e.g. a screen lock state, or a screen unlock state), and the interface is displayed by the system to the user for operating. However, in this embodiment, when the system invokes the call program to return the incoming call interface, a customized incoming call interface is returned to the system (for example, an interface with a mode of sliding “to the left” for rejecting a call and sliding “to the right” for answering a call), so that the incoming call interface initialized by the call program in the prior art may be omitted, and system operations may be simplified; in this embodiment, an incoming call is answered or rejected on the customized incoming call interface of a mobile terminal in a uniform slide mode, so that the efficiency and accuracy of the call answering or rejecting operation by a user may be improved.

Additionally, the default incoming call interface of the existing IOS system is too simple, and a user cannot modify the background of the system incoming call interface or the pattern of the slide answering button, etc., according to individual preference. After the solution according to this embodiment is employed, because the entire incoming call interface is created and controlled by the user himself, an incoming call interface with various customized patterns may be provided, and the user may modify the background of the incoming call interface and replace the background image of the incoming call interface, so that the incoming call interface can be made more vivid.

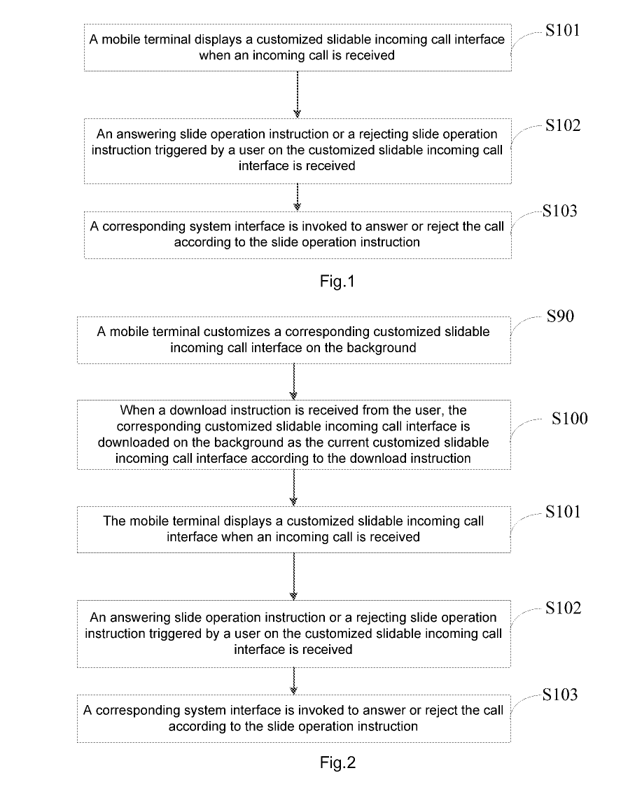

As shown in FIG. 2, another embodiment of the disclosure puts forward an incoming call processing method of a mobile terminal. Based on the above one embodiment, the method further includes the following steps before the above Step S101:

Step S90: customizing, by the mobile terminal, a corresponding customized slidable incoming call interface on the background; and

Step S100: when a download instruction is received from the user, downloading the corresponding customized slidable incoming call interface on the background as the current customized slidable incoming call interface according to the download instruction.

This embodiment differs from the above one embodiment in that, in this embodiment, a corresponding slidable incoming call interface may be customized as desired by the user.

Specifically, the mobile terminal may provide, on the background, a slidable incoming call interface of various customized patterns to the user for selecting, and the user may download a corresponding slidable incoming call interface on the background as the current customized slidable incoming call interface according to individual preference. When receiving an incoming call, the mobile terminal displays the slidable incoming call interface previously downloaded by the user for operating, so that the requirement for individualized operation of the user can be met. The other aspects of the present embodiment are the same as those of one embodiment.

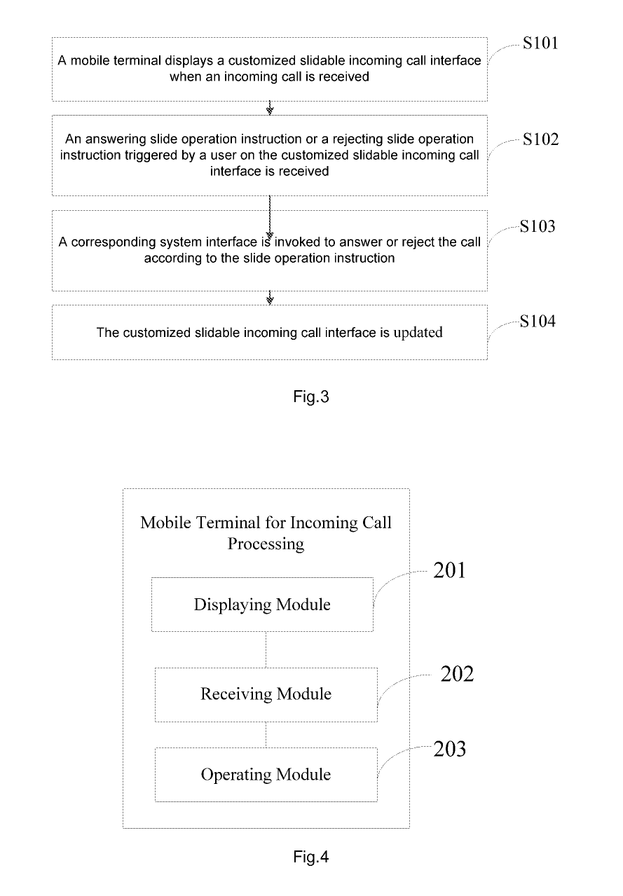

As shown in FIG. 3, yet another embodiment of the disclosure puts forward an incoming call processing method of a mobile terminal. Based on the above one embodiment, the method further includes the following step S104 after the above Step S103:

Step S104: updating the customized slidable incoming call interface.

This embodiment differs from the above one embodiment in that, in this embodiment, a user is allowed to update the slidable incoming call interface. The mobile terminal provides incoming call interfaces with various customized patterns to the user on the background, and the user may modify the background of the incoming call interface and replace the background image of the incoming call interface according to individual preference, so that the incoming call interface can be made more vivid, and the requirement for individualized operation of the user can be met.

As shown in FIG. 4, one embodiment of the disclosure puts forward a mobile terminal for processing an incoming call, which includes: a displaying module 201, a receiving module 202 and an operating module 203, where:

the displaying module 201 is configured to display a customized slidable incoming call interface when an incoming call is received;

the receiving module 202 is configured to receive an answering slide operation instruction or a rejecting slide operation instruction triggered by a user on the customized slidable incoming call interface; and

the operating module 203 is configured to invoke a corresponding system interface to answer or reject the incoming call according to the received slide operation instruction.

The solution according to this embodiment may be applied to the IOS system platform or other system platforms, and the description is given herein by taking the IOS system platform as an example. The mobile terminal in this embodiment may be a mobile phone, an iPAD, etc.

In this embodiment, the two different answering solutions provided by the existing IOS system platform may be integrated, and the mode of answering or rejecting an incoming call by sliding on the incoming call interface may be provided to a user in both the screen lock state and the screen unlock state, for example, the incoming call is rejected by sliding “to the left” and answered by sliding “to the right”. In such a mode, the learning cost of a user is reduced, and the maloperation which may occur in the case of pressing a button may be avoided.

Specifically, in this embodiment, when an incoming call is received by a mobile terminal, the displaying module 201 displays an incoming call interface on the mobile terminal to allow the user to perform a slide operation on the incoming call interface, where, this incoming call interface is a slidable incoming call interface customized by the user, and may be various slide operation interfaces customized by the user in advance according to individual preference, for example, the user may defines to reject a call by sliding to the left on the interface and to answer a call by sliding to the right on the interface, or defines to reject a call by sliding up and to answer a call by sliding down on the interface, or in other slide modes.

Further, the user may also define the slidable incoming call interface as a static or dynamic interface as required, for example, a dynamic background picture is set for the incoming call interface; or, the incoming call interface is set as a ringing interface carrying the corresponding incoming call number, etc.

After the mobile terminal receives an incoming call, the user performs a corresponding slide operation as required on the incoming call interface of the mobile terminal according to the slide mode displayed on the incoming call interface, so as to trigger the mobile terminal to answer or reject the incoming call.

After the receiving module 202 of the mobile terminal receives the slide operation instruction input by the user, the operating module 203 performs the corresponding operation, for example, when the user slides to the left on the customized incoming call interface as displayed, the operating module 203 invokes a call rejecting interface of the system; and when the user slides to the right, the operating module 203 invokes a call answering interface of the system. Therefore, the corresponding call operation will be implemented.

When the user rejects a call, the system may also conduct a corresponding shortcut reply, for example, by sending a prompt short message such as “in conference”, “in class”, etc., to the caller.

For example, for the existing IOS system platform, when a call is received, a system call program is invoked to initialize and generate an incoming call interface, and the system call program returns different answering and rejecting interfaces according to the current state of the IOS system (e.g. a screen lock state, or a screen unlock state), and the interface is displayed by the system to the user for operating. However, in this embodiment, when the system invokes the call program to return the incoming call interface, a customized incoming call interface is returned to the system (for example, an interface with a mode of sliding “to the left” for rejecting a call and sliding “to the right” for answering a call), so that the incoming call interface initialized by the call program in the prior art may be omitted, and system operations may be simplified; in this embodiment, an incoming call is answered or rejected on the customized incoming call interface of a mobile terminal in a uniform slide mode, so that the efficiency and accuracy of the call answering or rejecting operation by a user may be improved.

Additionally, the default incoming call interface of the existing IOS system is too simple, and a user cannot modify the background of the system incoming call interface or the pattern of the slide answering button, etc., according to individual preference. After the solution according to this embodiment is employed, because the entire incoming call interface is created and controlled by the user himself, an incoming call interface with various customized patterns may be provided, and the user may modify the background of the incoming call interface and replace the background image of the incoming call interface, so that the incoming call interface can be made more vivid.

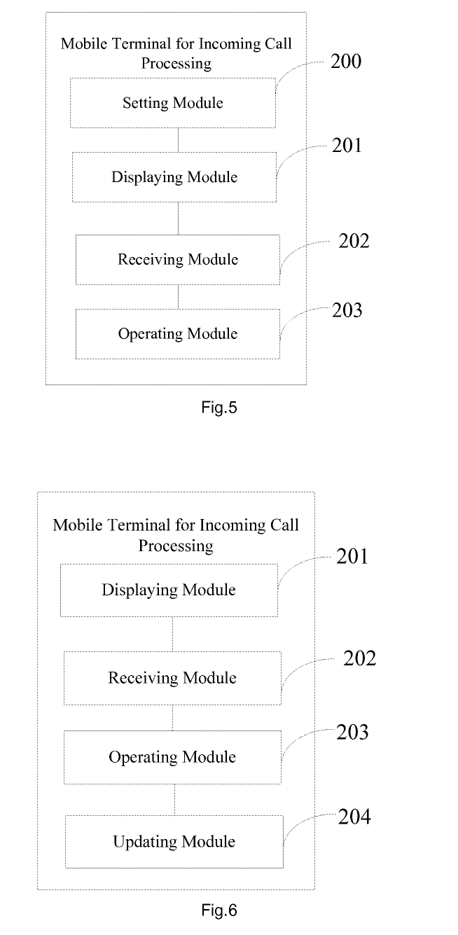

As shown in FIG. 5, another embodiment of the disclosure puts forward a mobile terminal for processing an incoming call. Based on the above one embodiment, the mobile terminal further includes:

a setting module 200 configured to: customize a corresponding customized slidable incoming call interface on the background; and when receiving a download instruction from the user, download the corresponding customized slidable incoming call interface on the background as the current customized slidable incoming call interface according to the download instruction.

This embodiment differs from the above one embodiment in that, in this embodiment, a corresponding slidable incoming call interface may be customized according to user requirement.

Specifically, the mobile terminal may provide, on the background, a slidable incoming call interface with various customized patterns to the user for selecting, and the user may download a corresponding slidable incoming call interface on the background as the current customized slidable incoming call interface according to individual preference. When an incoming call is received by the mobile terminal, the mobile terminal displays the slidable incoming call interface downloaded by the user previously for user operating, so that the requirement for individualized operation of the user can be met. The other part is the same as that of one embodiment.

As shown in FIG. 6, yet another embodiment of the disclosure puts forward a mobile terminal for processing an incoming call. Based on the above one embodiment, the mobile terminal further includes:

an updating module 204, configured to update the customized slidable incoming call interface.

This embodiment differs from the above one embodiment in that, in this embodiment, a user may update the slidable incoming call interface. The mobile terminal provides incoming call interfaces with various customized patterns to the user on the background, and the user may modify the background of the incoming call interface and replace the background image of the incoming call interface according to individual preference, so that the incoming call interface can be made more vivid, and the requirement for individualized operation of the user can be met.

The disclosure further puts forward an embodiment, which provides a storage medium containing computer-executable instructions, and the computer-executable instructions are configured to perform an incoming call processing method of a mobile terminal, and the method includes steps of:

displaying, by a mobile terminal, a customized slidable incoming call interface when an incoming call is received;

receiving an answering slide operation instruction or a rejecting slide operation instruction triggered by a user on the customized slidable incoming call interface; and

invoking a corresponding system interface to answer or reject the call according to the received slide operation instruction.

In the incoming call processing method of a mobile terminal and the mobile terminal according to the embodiments of the disclosure, an incoming call answering or rejecting operation is performed on a customized incoming call interface of a mobile terminal in a uniform slide mode, so that the efficiency and accuracy of the call answering or rejecting operation of a user may be improved; additionally, the pattern of an incoming call interface, etc., may also be customized according to user requirement, thus the operation of a user on an incoming call may be facilitated, and the shortage of the prior art, especially of the call answering in an IOS system, may be covered.

The above description only shows some preferred embodiments of the disclosure, rather than limiting the scope of the disclosure. All equivalent structural or flow transformations made in light of the contents of the specification and drawings of the disclosure, which are applied directly or indirectly to other related technical fields, are included in the protection scope of the disclosure.

What is claimed is:

1. An incoming call processing method of a mobile terminal, comprising:
displaying, by a mobile terminal, a customized slidable incoming call interface when an incoming call is received;
receiving an answering slide operation instruction or a rejecting slide operation instruction triggered by a user on the customized slidable incoming call interface; and
invoking a corresponding system interface to answer or reject the call according to the received slide operation instruction.

2. The method according to claim 1, wherein, the slide operation instruction at least comprises a left or right sliding operation instruction or an up or down sliding operation instruction; and the customized slidable incoming call interface is a static or dynamic interface, or a ringing interface carrying the corresponding incoming call number.

3. The method according to claim 2, wherein, receiving an answering slide operation instruction or a rejecting slide operation instruction triggered by a user on the customized slidable incoming call interface comprises:
receiving an answering operation instruction triggered by the user via sliding to the right on the customized slidable incoming call interface.

4. The method according to claim 2, wherein, receiving an answering slide operation instruction or a rejecting slide operation instruction triggered by a user on the customized slidable incoming call interface comprises:
receiving a rejecting operation instruction triggered by the user via sliding to the left on the customized slidable incoming call interface.

5. The method according to claim 1, wherein, before displaying, by a mobile terminal, a customized slidable incoming call interface when an incoming call is received, the method further comprises:
customizing, by the mobile terminal, a corresponding customized slidable incoming call interface on a background; and
when receiving a download instruction from the user, downloading the corresponding customized slidable incoming call interface on the background as the current customized slidable incoming call interface according to the download instruction.

6. The method according to claim 1, further comprising:
updating the customized slidable incoming call interface.

7. The method according to claim 2, further comprising:
updating the customized slidable incoming call interface.

8. The method according to claim 3, further comprising:
updating the customized slidable incoming call interface.

9. The method according to claim 4, further comprising:
updating the customized slidable incoming call interface.

10. The method according to claim 5, further comprising:
updating the customized slidable incoming call interface.

11. The method according to claim 1, wherein, invoking a corresponding system interface to reject the call according to the received slide operation instruction comprises:
invoking a system rejecting interface according to the slide operation instruction received, and sending a corresponding prompt message to the caller.

12. A mobile terminal for processing an incoming call, comprising:
a displaying module, configured to display a customized slidable incoming call interface when an incoming call is received;
a receiving module, configured to receive an answering slide operation instruction or a rejecting slide operation instruction triggered by a user on the customized slidable incoming call interface; and
an operating module, configured to invoke a corresponding system interface to answer or reject the call according to the received slide operation instruction.

13. The mobile terminal according to claim 12, wherein, the receiving module is further configured to: receive an answering operation instruction triggered by the user via sliding to the right on the customized slidable incoming call interface.

14. The mobile terminal according to claim 12, wherein, the receiving module is further configured to: receive a rejecting operation instruction triggered by the user via sliding to the left on the customized slidable incoming call interface.

15. The mobile terminal according to claim 12, further comprising:
a setting module, configured to: customize a corresponding customized slidable incoming call interface on a background; and when receiving a download instruction from the user, download the corresponding customized slidable incoming call interface on the background as the current customized slidable incoming call interface according to the download instruction.

16. The mobile terminal according to claim 12, further comprising:
an updating module, configured to update the customized slidable incoming call interface.

17. The mobile terminal according to claim 13, further comprising:
an updating module, configured to update the customized slidable incoming call interface.

18. The mobile terminal according to claim 14, further comprising:
an updating module, configured to update the customized slidable incoming call interface.

19. The mobile terminal according to claim 8, wherein, the operating module is further configured to invoke a system rejecting interface according to a slide operation instruction, and send a corresponding prompt message to the caller.

20. A non-transitory computer-readable storage medium comprising computer-executable instructions, wherein, the computer-executable instructions are configured to perform an incoming call processing method of a mobile terminal, and the method comprises:
displaying, by a mobile terminal, a customized slidable incoming call interface when an incoming call is received;
receiving an answering slide operation instruction or a rejecting slide operation instruction triggered by a user on the customized slidable incoming call interface; and
invoking a corresponding system interface to answer or reject the call according to the received slide operation instruction.
